(19) United States
(12) Patent Application Publication
(10) Pub. No.: US 2009/0181119 A1
(43) Pub. Date: Jul. 16, 2009

(54) Lateral core-pulling mechanism of mold

(76) Inventors: Chih-Yu Chen, Tu-Cheng City (TW); Jian-Ren Wang, Tu-Cheng City (TW); Guo-Bing Xu, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,713

(22) Filed: Jan. 15, 2008

(51) Int. Cl. B28B 7/28

(52) U.S. Cl. 425/345

(57) ABSTRACT

A lateral core-pulling mechanism of mold includes a cavity plate, a cavity insert configured in the cavity plate and defining a shaping recess, and a core-pulling body including a first slide module longitudinally movably disposed in the front of the cavity plate, an angular pin, and two second slide modules movably disposed at two sides of the cavity insert. The first slide module defines an inclined hole, a first shaping core inserted into the shaping recess and two first guide surfaces at two side edges thereof. The angular pin has an inclined block inclining forward and movably received in the inclined hole to drive the first slide module to move forward or backward. The second slide module defines a second shaping core inserted into the shaping recess and a second guide surface slidably matching the corresponding first guide surface to drive the second slide module to move sideward.

### BACKGROUND OF THE INVENTION

1. Field of the Invention

The present invention generally relates to a mold mechanism, and more particularly to a lateral core-pulling mechanism of mold.

2. The Related Art

Traditionally, a lateral core-pulling mechanism of mold includes a cavity plate, a cavity insert and a plurality of independent core-pulling bodies. The cavity insert is configured in the cavity plate and defines a shaping recess for molding a plastic product. The core-pulling body includes a slide module movably received in the cavity plate, a shaping core connecting with the slide module indirectly and inserted into or withdrawn out of the shaping recess, and an angular pin. The slide module defines an inclined hole. The angular pin has an inclined block inserted into or withdrawn out of the inclined hole of the slide module. While the inclined block of the angular pin is withdrawn out of the inclined hole, the inclined block drives the slide module to move outward and further brings the shaping core to separate from the plastic product for defining a cavity in the plastic product. However, for the core-pulling bodies are independent with each other, the slide module is driven by the perspective angular pin to move. Therefore, the foregoing lateral core-pulling mechanism of mold occupies a large space and is more suitable for the cavities of a large plastic product. When the cavities of a small plastic product are molded, another lateral core-pulling mechanism of mold with a simple structure is required.

### SUMMARY OF THE INVENTION

An object of the present invention is to provide a lateral core-pulling mechanism of mold with a simple structure, which can mold a plurality of cavities of a small plastic product.

The lateral core-pulling mechanism of mold includes a cavity plate, a cavity insert and a core-pulling body. The cavity plate defines a recess in the top thereof, a first sliding cavity in front of the recess and communicating with the recess, and two second sliding cavities at two sides of the recess and communicating with the recess. The cavity insert is received in the recess of the cavity plate and defines a shaping recess in the top thereof for molding the plastic product. The core-pulling body includes a first slide module, an angular pin and two second slide modules. The first slide module is longitudinally movably disposed in the first sliding cavity of the cavity plate and defines an inclined hole, a first shaping core inserted into the shaping recess of the cavity insert, and two first guide surfaces at two side edges thereof. Each of the first guide surfaces inclines outward from front to rear. The angular pin has an inclined block inclining forward for being inserted into or withdrawn out of the inclined hole of the first slide module to drive the first slide module to move backward or forward so that the first shaping core can be inserted into or withdrawn out of the shaping recess of the cavity insert. Each of the second slide modules is transversely movably disposed in the two second sliding cavities of the cavity plate respectively and defines a second shaping core inserted into the shaping recess of the cavity insert, and a second guide surface slidably matching the corresponding first guide surface of the first slide module so as to be driven to move sideward, whereby the second shaping core can be withdrawn out of or inserted into the shaping recess of the cavity insert.

As described above, when the lateral core-pulling mechanism of mold is core-pulled or inserted, the angular pin drives the first slide module to slide forward or rearward. At this moment, the first guide surfaces and the corresponding second guide surfaces interact with each other, so the first slide module further drives the second slide modules to transversely move outward or inward for making the shaping cores separate from the plastic product or insert into the shaping recess. Therefore, the structure of the lateral core-pulling mechanism of mold is so simple that it is apt to mold the cavities of the small plastic product.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded perspective view of a lateral core-pulling mechanism of mold in accordance with the present invention;

FIG. 2 is a perspective view of a first mounting block of the lateral core-pulling mechanism of mold;

FIG. 3 is a perspective view of a core-pulling body of the lateral core-pulling mechanism of mold; and

FIG. 4 is a perspective view of the lateral core-pulling mechanism of mold of FIG. 1.

### DETAILED DESCRIPTION OF THE PREFERRED EMBODIMENT

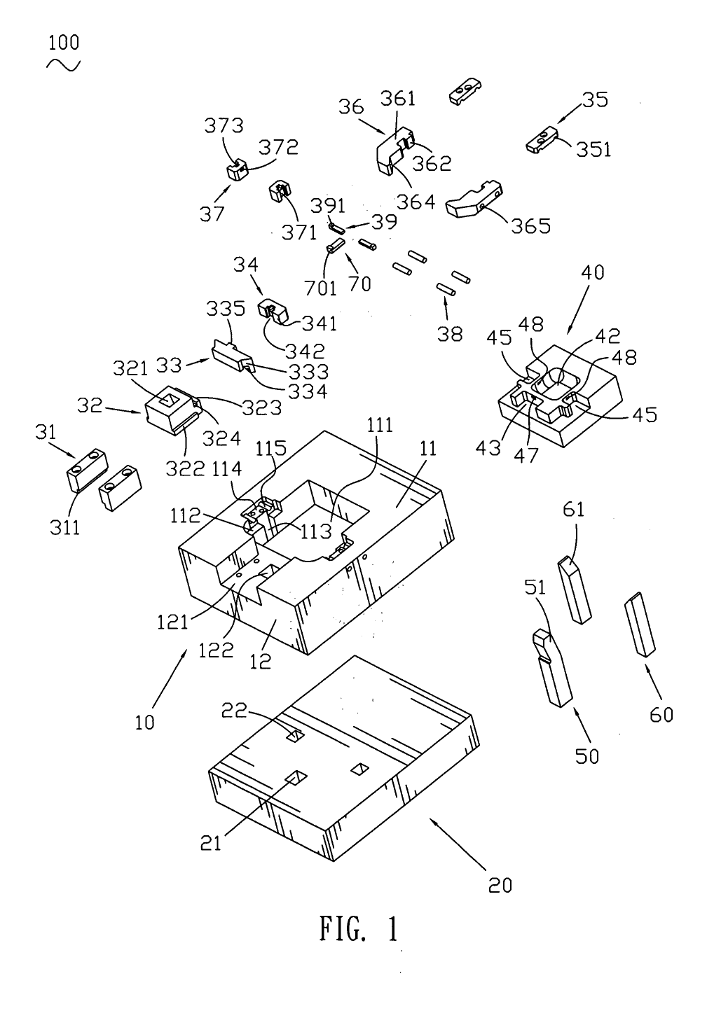

With reference to FIG. 1, a lateral core-pulling mechanism of mold 100 includes a cavity plate 10, a clamping plate 20, a core-pulling body 30, a cavity insert 40, an angular pin 50 and two upright pins 60.

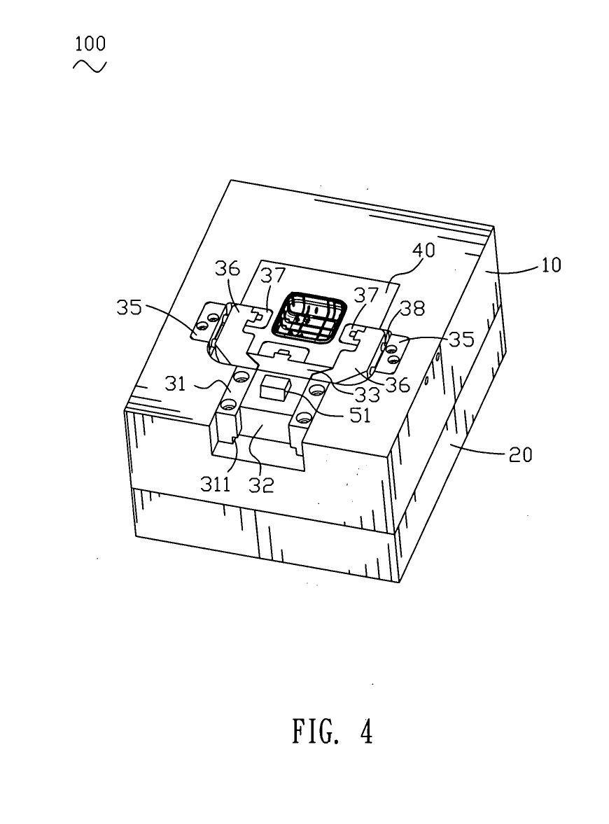

Referring to FIG. 1 and FIG. 4, the cavity plate 10 is of rectangular shape and defines a top wall 11 and a front wall 12. The top wall 11 defines a rectangular recess 111 in the middle thereof and a first sliding cavity 121 connecting the middle of the recess 111 and passing through the front wall 12. The bottom of the first sliding cavity 121 defines a sliding hole 122 penetrating the bottom of the cavity plate 10. Two second sliding cavities 112 are defined in the top wall 11 and respectively connect two sides of the recess 111 and two sides of the rear of the first sliding cavity 121. The bottom of the second sliding cavity 112 vertically defines a first perforation 113 penetrating the cavity plate 10 and communicating with the recess 111. The two first perforations 113 face to each other. The top wall 11 defines two fixing gaps 114 communicating with the respective second sliding cavities 112 and facing to each other. The bottom of the fixing gap 114 transversely defines two first semicircular troughs 115 adjacent to two sides of the first perforation 113. The clamping plate 20 is of rectangular shape and located under the cavity plate 10. The top of the clamping plate 20 defines a receiving hole 21 connecting the sliding hole 122 and two second perforations 22 connecting the corresponding first perforations 113. The top of the angular pin 50 defines an inclined block 51 inclining forward. The top of the upright pin 60 defines an inclined surface 61. The bottom of the angular pin 50 is fixed in the receiving hole 21 and the inclined block 51 passes through the sliding hole 122 to stretch into the first sliding cavity 121. The bottom of the upright pin 60 is fixed in the second perforation 22 and the inclined surface 61 passes through the first perforation 113 to stretch into the second sliding cavity 112. The two inclined surfaces 61 face to each other.

The cavity insert 40 is of rectangular shape and configured in the recess 111 of the cavity plate 10. The top of the cavity insert 40 defines a shaping recess 42 in the middle thereof for molding a plastic product (not shown) and a first space 43 in the front thereof. The rear of the first space 43 defines a first aperture 47 communicating with the shaping recess 42. Two sides of the top of the cavity insert 40 respectively define a second space 45 connecting the corresponding second sliding cavity 112. The second space 45 defines a second aperture 48 communicating with the shaping recess 42.

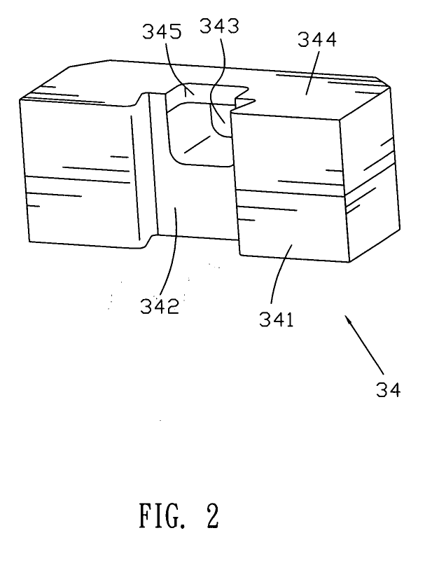

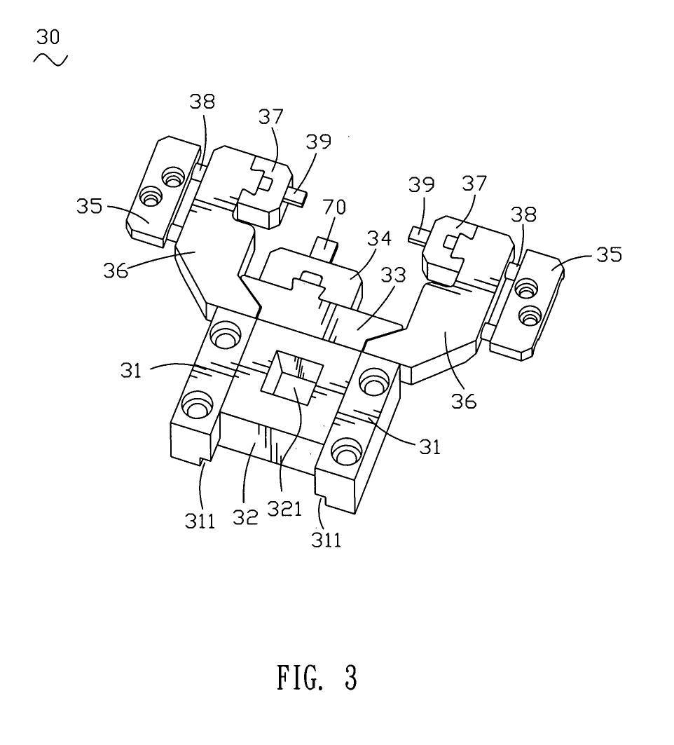

Referring to FIGS. 1-4, the core-pulling body 30 has a first slide module and a pair of second slide modules. The first slide module has a pair of first guide blocks 31, a first slide 32, a first mounting block 34, a first shaping core 70 and a connecting body 33 connecting with the first slide 32 and the first mounting block 34. The first slide 32 is of rectangular shape and longitudinally movably received in the first sliding cavity 121. The bottom of two sides of the first slide 32 respectively defines a slide rib 322 extending longitudinally. The first guide blocks 31 extend longitudinally and are respectively configured at two sides of the first slide 32. The bottom of the first guide block 31 defines a sliding channel 311 extending longitudinally for receiving the slide rib 322. The first slide 32 defines an inclined hole 321 penetrating from top to bottom and inclining forward. The inclined block 51 of the angular pin 50 is movably inserted in the inclined hole 321. The bottom of the rear of the first slide 32 protrudes rearward and then extends upward to form an L-shaped first locking block 323. A first locking channel. 324 is formed between the first slide 32 and the first locking block 323. The connecting body 33 is of swallow-tailed shape and defines two first guide surfaces 333 inclining outward from front to rear at the rear of two side edges. The bottom of the connecting body 33 defines a second locking channel 334 extending transversely for receiving the first locking block 323. The front of the connecting body 33 buckles into the first locking channel 324. The rear of the connecting body 33 protrudes rearward to form a swallow-tailed first locking section 335. The first mounting block 34 is of rectangular shape and movably received in the first space 43 of the cavity insert 40. The first mounting block 34 has a front surface 341 and a top surface 344. The front surface 341 concaves rearward to form a swallow-tailed first locking gap 342 for fixing the first locking section 335. The rear of the first locking gap 342 defines a first locking hole 343 penetrating the rear of the first mounting block 34 to connect the first aperture 47 of the cavity insert 40. The front of the first locking hole 343 extends upward to penetrate the top surface 344 for forming a first locking opening 345 communicating with the first locking gap 342. The first shaping core 70 extends longitudinally and defines a first preventing section 701 protruding upward from the front thereof. The first preventing section 701 is inserted in the first locking opening 345 and a rear end of the first shaping core 70 passes through the first locking hole 343 and the first aperture 47 to stretch into the shaping recess 42.

Each of the second slide modules has a second guide block 35, a second slide 36, a second mounting block 37, two guide pillars 38 and a second shaping core 39. The second guide block 35 is fastened in the corresponding fixing gap 114 of the cavity plate 10 and transversely defines two second semicircular troughs 351 at the bottom thereof matching with the first semicircular troughs 115 to define two circular troughs. The second slide 36 has a base plate 361 extending longitudinally. The rear of one side of the base plate 361 defines a swallow-tailed second locking section 362 facing to the second space 45. The front of the base plate 361 protrudes toward the same side to define a second guide surface 364 mating with the first guide surface 333. The other side of the base plate 361 defines two parallel guide perforations 365 extending inward transversely. The second slides 36 are transversely movably configured at two sides of the cavity insert 40 and received in the respective second cavities 112. The second guide surface 364 movably abuts against the corresponding first guide surface 333. One end of the guide pillar 38 is received in the guide perforation 365 and the other end of the guide pillar 38 is received in the circular trough. The second slide 36 can slide along the guide pillars 38. The inclined surface 61 of the upright pin 60 abuts against the outside of the second slide 36. The second mounting block 37 is the same as the first mounting block 34 and just only smaller. The second mounting block 37 is movably received in the second space 45 and defines a second locking gap 371 for fixing the second locking section 362, a second locking hole 372 and a second locking opening 373. The second shaping core 39 is the same as the first shaping core 70 and just only smaller. The second shaping core 39 defines a second preventing section 391 inserted in the second locking opening 373. A free end of the second shaping core 39 passes through the second locking hole 372 and the second aperture 48 to stretch into the shaping recess 42.

Referring to FIG. 4, when the plastic product molded in the shaping recess 42 of the cavity insert 40 is withdrawn out of the shaping recess 42, the clamping plate 20 moves downward to drive the angular pin 50 to move downward and further drive the inclined block 51 to move downward along the inclined hole 321 of the first slide 32. In the process of the angular pin 50 moving downward, the force coming from the inclined block 51 causes the first slide 32 to slide forward along the sliding channels 311 of the first guide block 31. Then it brings the connecting body 33, the first mounting block 34 and the first shaping core 70 to move forward to make the first shaping core 30 separate from the plastic product for defining a cavity of the plastic product. While the connecting body 33 moves forward, the force generated by the first guide surface 333 acts on the second guide surface 364 to drive the second slide 36 to move sideward along the guide pillar 38. Then it brings the second mounting block 37 and the second shaping core 39 to move sideward to make the second shaping core 39 separate from the plastic product for defining another smaller cavity of the plastic product.

As described above, when the lateral core-pulling mechanism of mold 100 is core-pulled or inserted, the angular pin 50 drives the first slide module to slide forward or rearward. At this moment, the first guide surfaces 333 of the connecting body 33 and the corresponding second guide surfaces 364 of the second slide 36 interact with each other, so the first slide module drives the second slide modules to transversely move outward or inward for making the shaping cores 70, 39 separate from the plastic product or insert into the shaping recess 42. Therefore, the structure of the lateral core-pulling mechanism of mold 100 is so simple that it is apt to mold the cavities of a small plastic product.

What is claimed is:

1. A lateral core-pulling mechanism of mold, comprising:
a cavity plate defining a recess in the top thereof, a first sliding cavity in front of the recess and communicating with the recess, and two second sliding cavities at two sides of the recess and communicating with the recess;
a cavity insert received in the recess of the cavity plate and defining a shaping recess in the top thereof; and
a core-pulling body, including
a first slide module longitudinally movably disposed in the first sliding cavity of the cavity plate, the first slide module defining an inclined hole, a first shaping core inserted into the shaping recess of the cavity insert, and two first guide surfaces at two side edges thereof, each of the first guide surfaces inclining outward from front to rear,
an angular pin having an inclined block inclining forward for being inserted into or withdrawn out of the inclined hole of the first slide module to drive the first slide module to move backward or forward so that the first shaping core can be inserted into or withdrawn out of the shaping recess of the cavity insert, and
two second slide modules transversely movably disposed in the two second sliding cavities of the cavity plate respectively, the second slide modules each having a second shaping core inserted into the shaping recess of the cavity insert and defining a second guide surface slidably matching the corresponding first guide surface of the first slide module so as to be driven to move sideward, whereby the second shaping core can be withdrawn out of or inserted into the shaping recess of the cavity insert.

2. The lateral core-pulling mechanism of mold as claimed in claim 1, wherein the first slide module has a first slide and a swallow-tailed connecting body connecting the rear of the first slide, the two first guide surfaces are respectively defined at two side edges of the connecting body.

3. The lateral core-pulling mechanism of mold as claimed in claim 2, wherein the bottom of the rear of the first slide protrudes rearward and then extends upward to form an L-shaped first locking block, a first locking channel is formed between the first slide and the first locking block, the bottom of the connecting body defines a second locking channel extending transversely for receiving the first locking block, the front of the connecting body buckles into the first locking channel.

4. The lateral core-pulling mechanism of mold as claimed in claim 2, wherein the first slide module further has a first mounting block connecting the rear of the connecting body, the top of the cavity insert defines a first space in the front thereof, the first space communicates with the shaping recess through a first aperture, the first mounting block is longitudinally movably received in the first space, one end of the first shaping core is fixed in the first mounting block and the other end of the first shaping core is inserted into the shaping recess through the first aperture.

5. The lateral core-pulling mechanism of mold as claimed in claim 4, wherein the rear of the connecting body protrudes rearward to form a swallow-tailed first locking section, the front of the first mounting block concaves rearward to form a swallow-tailed first locking gap fixing the first locking section therein.

6. The lateral core-pulling mechanism of mold as claimed in claim 4, wherein the rear of the first mounting block defines a first locking hole aligning with the first aperture of the cavity insert, the front of the first locking hole extends upward to penetrate the top of the first mounting block to form a first locking opening, the first shaping core defines a first preventing section protruding upward from the front thereof and inserted in the first locking opening and passes through the first locking hole.

7. The lateral core-pulling mechanism of mold as claimed in claim 1, wherein each of the second slide modules has a second slide and a second mounting block connecting the second slide, the top of the cavity insert defines two second spaces at two sides thereof, each of the second spaces communicates with the shaping recess through a second aperture, the second mounting block is transversely movably received in the corresponding second space, one end of the second shaping core is fixed in the second mounting block and the other end of the second shaping core is inserted into the shaping recess through the second aperture.

8. The lateral core-pulling mechanism of mold as claimed in claim 7, wherein the second slide protrudes inward to form a swallow-tailed second locking section, the second mounting block concaves inward to form a swallow-tailed second locking gap fixing the second locking section therein.

9. The lateral core-pulling mechanism of mold as claimed in claim 7, wherein the inside of the second mounting block defines a second locking hole aligning with the second aperture of the cavity insert, an outer end of the second locking hole extends upward to penetrate the top of the second mounting block to form a second locking opening, the second shaping core passes through the second locking hole and defines a second preventing section protruding upward from an outer end thereof, the second preventing section is inserted in the second locking opening.

10. The lateral core-pulling mechanism of mold as claimed in claim 1, wherein each of the second slide modules has a second slide, a second guide block and a plurality of guide pillars, the outside of the second slide defines a plurality of guide perforations transversely extending inward for receiving one end of the respective guide pillars, the top of the cavity plate defines a fixing gap communicating with the outside of the respective second sliding cavity for mounting the second guide block therein, a plurality of circular troughs are transversely defined between the bottom of the fixing gap and the bottom of the second guide block for receiving the other ends of the guide pillars.
